(19) United States
(12) Patent Application Publication
(10) Pub. No.: US 2016/0075282 A1
(43) Pub. Date: Mar. 17, 2016

(54) Vehicle Monitoring, Safety, and Tracking System

(71) Applicant: Christian Johnson, Williamsville, NY (US)

(72) Inventor: Christian Johnson, Williamsville, NY (US)

(21) Appl. No.: 14/852,362

(22) Filed: Sep. 11, 2015

Related U.S. Application Data
(60) Provisional application No. 62/049,340, filed on Sep. 11, 2014.

(51) Int. Cl. B60R 1/00; G01S 19/13

(52) U.S. Cl. CPC B60R 1/00; G01S 19/13; B60R 2300/8073

(57) ABSTRACT

Devices and systems for vehicle monitoring, safety, and tracking are disclosed. Devices related to the present disclosure have a housing having at least one actuator, two or more flexible arms having attached video cameras, a processor positioned within the housing, the processor in electronic communication with each of the video cameras, a GPS receiver, and an accelerometer. The device can transmit and receive data wirelessly through a transceiver. A central server may be associated with one or more of the devices and allow users to track vehicle status remotely.

### CROSS-REFERENCE TO RELATED APPLICATIONS

This application claims priority to U.S. Provisional Application No. 62/049,340, filed on Sep. 11, 2015, now pending, the disclosure of which is incorporated herein by reference.

### FIELD

The present disclosure relates to systems adapted to provide individuals with a means to ensure the safety and security of their vehicles. More particularly, the present disclosure pertains to a system adapted to provide users with the ability to monitor the driving habits of other individuals driving their car, track the location of their automobile, and shut down their car in emergency situations.

### BACKGROUND

Individuals are constantly looking for ways to keep their automobile and the drivers and passengers using their automobile safer and more secure. Keeping one's vehicle, and the individuals using the vehicle, safe and secure is a many-faceted problem and no currently-available vehicle monitoring systems adequately address all of these issues. First, car owners need to ensure that the other people driving their car are doing so in a safe and responsible manner. If an individual is not driving the owner's car safely, then that owner needs to know that fact so that he or she can take corrective measures. Current vehicle monitoring systems provide owners with general, broad statistics as to how their automobile is being driven. However, such statistics are difficult to apply in practice because they lack context. Therefore, there is a need in the prior art for a device that is adapted to provide automobile owners with a more nuanced and specific means for monitoring individuals driving the owners' automobiles.

Second, no currently available systems seamlessly integrate multiple different means for ensuring that one's vehicle remains safe and secure. One way of ensuring that a vehicle remains secure is to provide a means of locating the vehicle when lost or stolen so that it can be retrieved expeditiously. Another way of ensuring that a vehicle remains secure is to provide detailed information as to any mechanical or electrical issues that arise with the vehicle, thereby allowing the owner to take the proper corrective measures swiftly. Therefore, there is a need in the prior art for a system that provides a complete, holistic means for ensuring that safety and security of a vehicle, which integrates multiple different types of systems that monitor different variables associated with the vehicle.

### BRIEF SUMMARY

One embodiment of the present disclosure can be described as a vehicle monitoring and tracking device.

The vehicle monitoring and tracking device has a housing. The housing contains at least one actuator, for example, a button.

The device has two or more flexible arms. Each arm as a first end and a second end. The first end of each arm attaches to the housing. The second end of each arm has an attached video camera. Each camera may be connected to the processor through a cavity in each flexible arm.

The device also has a GPS receiver, accelerometer, a wireless data transceiver, and an electronic data storage unit in electronic communication with a processor.

The processor is positioned within the housing. The processor in electronic communication with each of the video cameras. The processor is configured to receive video from each video camera. The processor is also configured to store the video from each video camera in the electronic data storage unit. Video may only be received and stored when the vehicle is in motion.

The processor is also configured to receive acceleration data and GPS data from the accelerometer and GPS receiver. The processor is also configured to transmit, using the wireless data transceiver, at least a portion of the video, accelerometer data, and GPS data to a central server. The processor is also configured to receive input from the at least one actuator to control the operation of the device. The processor may be further configured to temporally associate the acceleration data and GPS data with the received video from each camera.

The device of claim may further comprise an OBD-II interface configured to pass vehicle information to the processor. The OBD-II interface may pass vehicle information to the processor using RF communications (wirelessly) or through a wired connection.

The device may further comprise a mount configured to be removably attached to a surface in the vehicle.

The present disclosure may also be embodied as a vehicle monitoring and tracking system. The system may comprise a plurality of vehicle tracking units as described above.

The system further comprises a central server having a processor and electronic storage unit. The central server processor may be configured to receive video from each of the vehicle tracking units. The central server processor may also be configured to store at least a portion of the video from each of the vehicle tracking units in the electronic storage unit, such that the vehicle tracking unit is permanently associated with the stored video. The processor may be further configured to store at least a portion of the GPS data and acceleration data from each of the vehicle tracking units, such that the vehicle tracking unit is permanently associated with the stored video. The central server processor may be further configured to receive geofencing data associated with one of the plurality of vehicle tracking units.

The processor of the central server may further be configured to, upon a user's request, transmit data to one of the plurality of vehicle tracking units. The data may be a shutdown command for the vehicle or a command to move at least one of the cameras of the vehicle tracking unit. The transmitted data may also be voice data which is played over one of the vehicle tracking units.

The electronic storage unit of the central server may contain emergency contact information associated with each of the plurality of vehicle tracking units. The processor may be further configured to send a communication to the emergency contact information associated with the vehicle tracking unit upon one or more pre-determined parameters.

One embodiment of the present disclosure comprises two main systems: a camera system and a module system in wireless communication therewith. The camera system provides owners of the automobile with the means to directly monitor the activities of another individual driving their automobile in real-time. This provides users with a nuanced, specific means for ensuring that a given driver is using the automobile in a safe and responsible manner. The camera system automatically uploads captured video to a cloud-based computing system, allowing users to access real-time recorded video via a web-based portion, a mobile electronic device software application, or another such means. An alternative embodiment of the camera system further comprises means to continuously transmit the location of the vehicle so that it may be located when misplaced or stolen and tracked in real-time. The module system is connectable to the automobile's on-board diagnostics port, via an OBD-II interface or another such interface protocol. The module system continuously tracks a variety of variables associated with the vehicle, such as average miles per gallon, and provides users with a means to analyze and clear vehicle warning lights that arise. This allows users to analyze any issues with their car so that they can determine the proper corrective measures to take. The module system further comprises a means for safely shutdown the vehicle in emergency situations, which is remotely accessible via a web-based portal or a software application adapted for use with mobile electronic devices.

### DESCRIPTION OF THE DRAWINGS

For a fuller understanding of the nature and objects of the disclosure, reference should be made to the following detailed description taken in conjunction with the accompanying drawings, in which:

FIG. 1 shows a perspective view of one camera system of the present disclosure.

FIG. 2 shows a perspective view of one camera system of the present disclosure, including the swiveling lenses.

FIG. 3 shows an alternative perspective view of one camera system of the present disclosure, including the swiveling lenses.

FIG. 4 shows a side view of one camera system of the present disclosure, including the swiveling lenses.

FIG. 5 shows a top-down view of the camera system of the present disclosure, including the swiveling lenses.

FIG. 6 shows a view of the module system of one embodiment of the present disclosure.

FIG. 7 shows a perspective view of one embodiment of the present disclosure.

FIG. 8 shows another perspective view of one embodiment of the present disclosure.

FIG. 9 shows a top view of one embodiment of the present disclosure.

FIG. 10 shows an alternative perspective view of one embodiment of the present disclosure.

FIG. 11 shows a view of the module system of one embodiment of the present disclosure

### DETAILED DESCRIPTION

One disclosed embodiment can be described as a vehicle monitoring and tracking device. The term vehicle may include automobiles, trucks, motorcycles, airplanes, and other powered vehicles.

The tracking device may have a housing having at least one actuator. The housing may be made from plastic, metal, or another durable material. The actuator may be a button, wheel, know, switch, or other user input device, such as a touch sensor. The housing may contain multiple actuators, each of a different type.

The tracking device may have two or more flexible arms. The arms may be partially flexible, such that some portion of the arm cannot be bent. Each arm may have a first end and a second end. The first end of each arm may be attached to the housing. the second end of each arm may have a video camera. The video camera may be separate from the arm but attached to the arm. The video camera may also be part of the arm or reside within a portion of the arm.

The tracking device may also comprise a processor positioned within the housing. The processor may be powered by a rechargeable battery or may receive power directly from the vehicle, or a combination of the two. The processor may be in electronic communication with each of the video cameras. The processor may communicate with each of the cameras wirelessly, or through a hard-wired connection. For example, the cameras may be connected by a wire placed within each arm.

The tracking device may also comprise a GPS receiver in electronic communication with the processor. The GPS receiver may receive satellite signals and contain logic capable of determining a location, speed, and direction of the vehicle. The GPS receiver may act as an accelerometer, or a separate accelerometer may be used in conjunction with the GPS receiver.

The tracking device may also comprise a wireless data transceiver in electronic communication with the processor. The wireless data transceiver may be a cellular data transceiver, a Bluetooth transceiver, or another type of transceiver capable of wirelessly transmitting data.

The device may also comprise an electronic data storage unit in electronic communication with the processor. The electronic data storage unit may be a hard drive or flash drive. Other types of data storage may be used, including removable SD cards.

The processor may be configured to receive video from each video camera. The received video may be compressed. The processor is also configured to store the video from each video camera into the electronic data storage unit. The processor may store only a portion of the video, or select the resolution of the video based on, for example, the electronic data storage unit size or user preferences. The processor may also be configured to receive acceleration data and GPS data from the accelerometer and GPS receiver. The processor may also be configured to transmit, using the wireless data transceiver, at least a portion of the video, accelerometer data, and GPS data to a central server. The processor may cause the transceiver to transmit some or all of the video. The video may be transmitted with a delay or while the device is not recording video. The user of the device may control when video is being sent, for example, by using an actuator (i.e., button) on the device. The actuator or actuators may be used to control other operations of the device.

In one embodiment, the device may further comprise an OBD-II interface. The OBD-II interface may be configured to pass vehicle information to the processor. The interface can perform this wirelessly or by using a wired connection.

The device may also comprise a mount configured to be removably attached to a surface in the vehicle. For example, the mount may be a suction cup or adhesive surface. The mount may also be a clamping unit configured to grasp a portion of the interior of the vehicle.

The device may be incorporated into a system comprising a central server having a processor and electronic storage unit. The central server may be a collection of computers in a variety of locations, i.e., a cloud computing configuration. Likewise the electronic storage unit may be a distributed collection of electronic storage units working in combination.

The processor of the central server may be configured to receive video from each of the vehicle tracking units. The processor may also be configured to store at least a portion of the video from each of the vehicle tracking units in the electronic storage unit, such that the vehicle tracking unit is permanently associated with the stored video. For example, each video may be assigned an identifier linking it to a particular tracking device.

The processor of the central server may be further configured to store at least a portion of the GPS data and acceleration data from each of the vehicle tracking units, such that the vehicle tracking unit is permanently associated with the stored video. The processor may embed the acceleration and GPS data directly on the video so that it can be viewed simultaneously as the video.

In one embodiment, the processor of the central server is further configured to, upon a user's request, transmit data to one of the plurality of vehicle tracking units. For example, this can be performed from a web front-end. On the front-end the user may send commands or instructions to one or more devices. For example, the user may send a shutdown command for the vehicle or a command to move at least one of the cameras of the vehicle tracking unit. Voice information can be sent to the device, at which time the device can play the voice information through one or more integrated speakers, or the speakers of the vehicle.

As used herein, “logic” refers to (i) logic implemented as computer instructions and/or data within one or more computer processes and/or (ii) logic implemented in electronic circuitry. As used herein, “computer-readable medium” excludes any transitory signals, but includes any non-transitory data storage circuitry, e.g., buffers, cache, and queues, within transceivers of transitory signals.

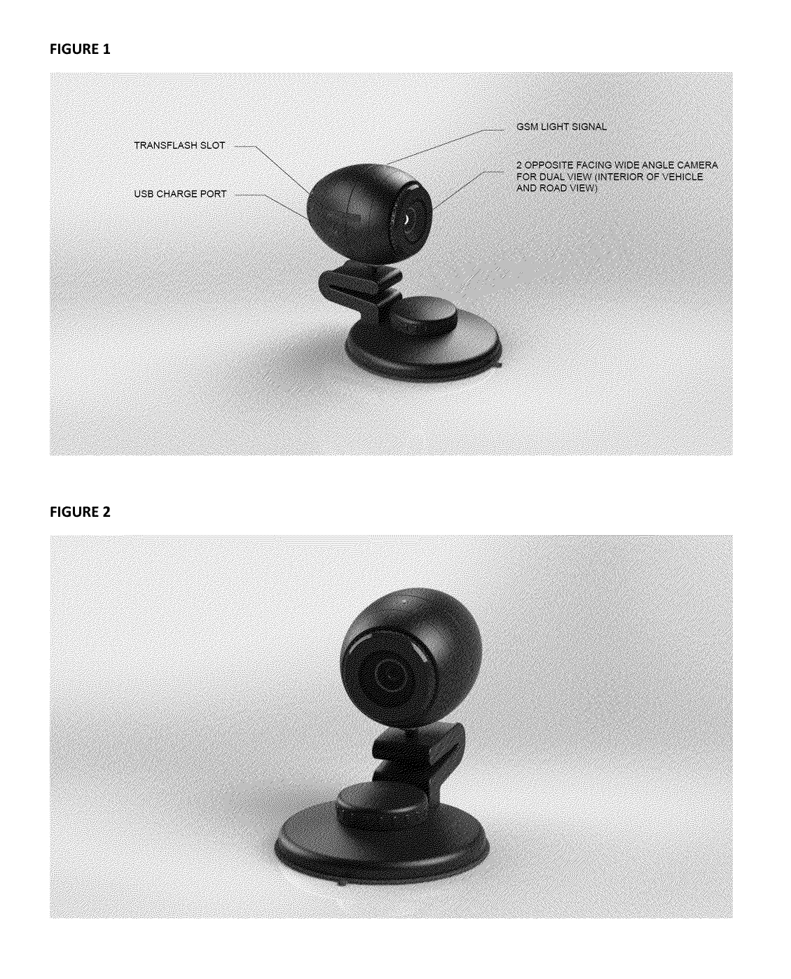

Referring now to FIG. 1, there is shown a perspective view of one embodiment of the camera system of the present disclosure. This embodiment of the camera system portion of the present disclosure comprises a bi-directional camera that is adapted to be affixed to an automobile's rear view mirror, a wireless transceiver, and logic adapted to implement commands received via said wireless transceiver. The bi-directional camera comprises a pair of oppositely-facing lenses. One of the lenses is positioned to provide a view of the road in front if the vehicle, whereas the opposing camera lens is positioned to provide individuals monitoring the video fee with a view of the driver and the vehicle's passengers. This arrangement provided several benefits. First, by providing a directly viewable, real-time view of the road, individuals are able to monitor the driver's driving habits to ensure that he or she is driving in a safe and responsible manner. Second, by providing a view of the interior of the vehicle, including the driver and the passengers, the vehicle owner is able to ensure that the individuals within the car are not engaging in risky behaviors, such as texting while driving. Furthermore, if the vehicle is stolen, then the internally-facing camera is able to provide authorities with a clear picture of the perpetrator and any co-conspirators to assist in them being brought to justice.

Video footage is recorded by the bi-directional camera and uploaded seamlessly to a cloud-based computing system for access by the vehicle owner. In one embodiment of the present disclosure, the camera continuously records and uploads video regardless of whether the car is activated at the time. In another embodiment of the present disclosure, the camera continuously records and uploads video whenever the car engine is turned on. In yet another embodiment of the present disclosure, the camera continuously records and uploads video whenever the car engine is turned on and the vehicle is in motion, as determined by an integral GPS system, an accelerometer, or another system or device that is adapted to detect movement. In still yet another embodiment of the present disclosure, the camera records video only when the system is accessed via the web portal or software application in communication therewith.

The present disclosure further comprises an integral GPS location feature that is accessible via the aforementioned web portal or software application. The GPS systems allows individuals to locate their vehicle if it is stolen or misplaced and track the location of the vehicle in real-time so that the vehicle can be retrieved. In an exemplary embodiment of the present disclosure, the GPS system automatically uploads the location of the vehicle whenever the vehicle's ignition key is turned to the “On” position. The GPS system will then regularly upload an updated location to the servers as the vehicle is in motion until the vehicle is turned off. The tracked movement between the vehicle being turned on and off is then saved into the system as a “trip” that can be accessed at a later time. Users can access a variety of variables associated with each of the trips, thereby providing an additional means by which they are able to monitor the driving habits of individuals other than themselves who are driving their vehicle. Optionally, users can configure the GPS system to automatically update the location of the vehicle and upload that location to the servers at regular intervals, regardless of whether the vehicle is turned on or not.

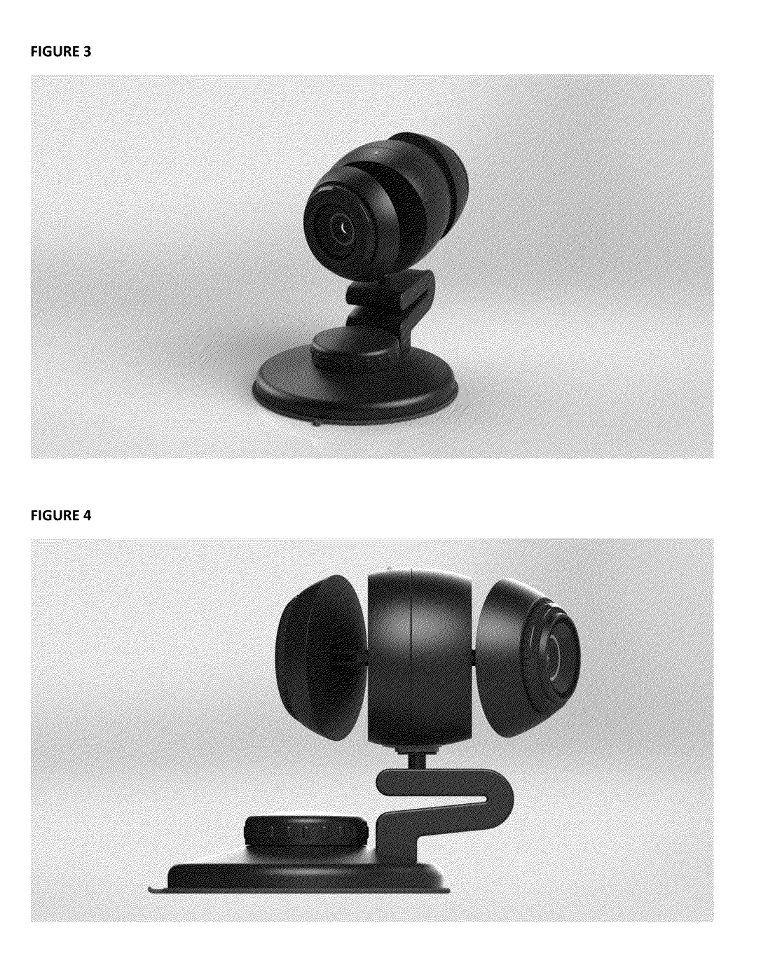

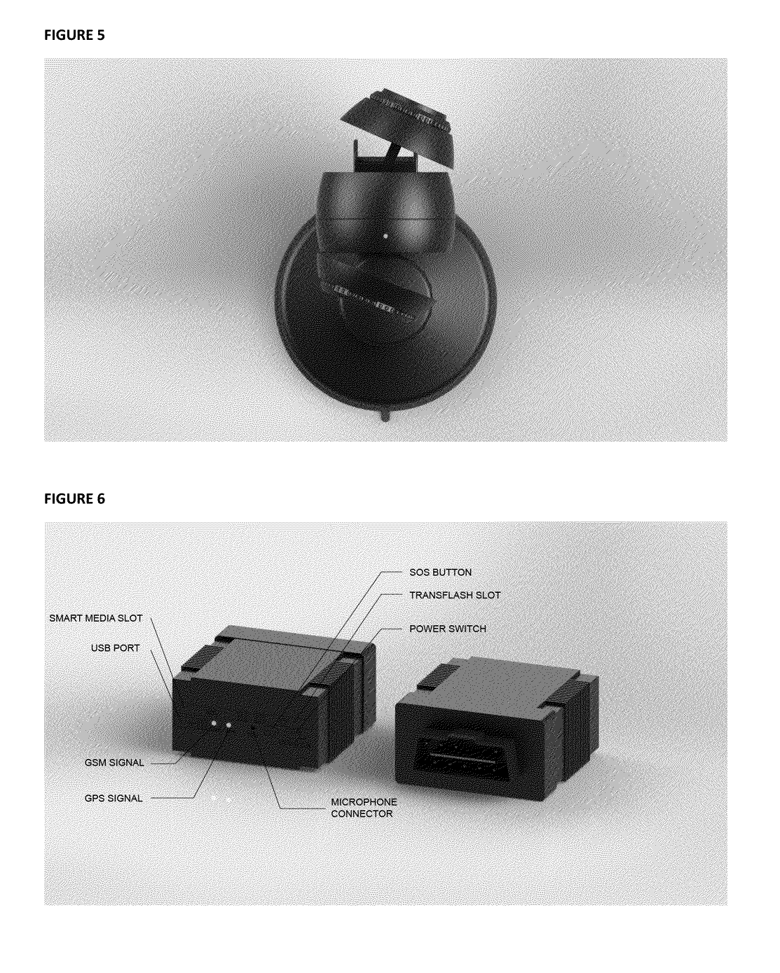

Referring now to FIGS. 2-5, there are shown various views of the camera system of the present disclosure, including the swiveling lenses. The lenses of the bi-directional camera are attached to the housing of the camera via a swivel mechanism that allows to pivot and rotate independently of each other. The swiveling mechanism provides users with greater field of view than conventional stationary lenses and the ability to adjust the focus of their view as needed. In a preferred embodiment of the present disclosure, the user is able to control the orientation of the lenses via the web portal, software application, or other means of wirelessly accessing the present camera system. The signals transmitted to the camera system are received by the integral wireless transceiver and translated by the logic stored therein into directional commands, which are then used to pivot or rotate one or both of the lenses.

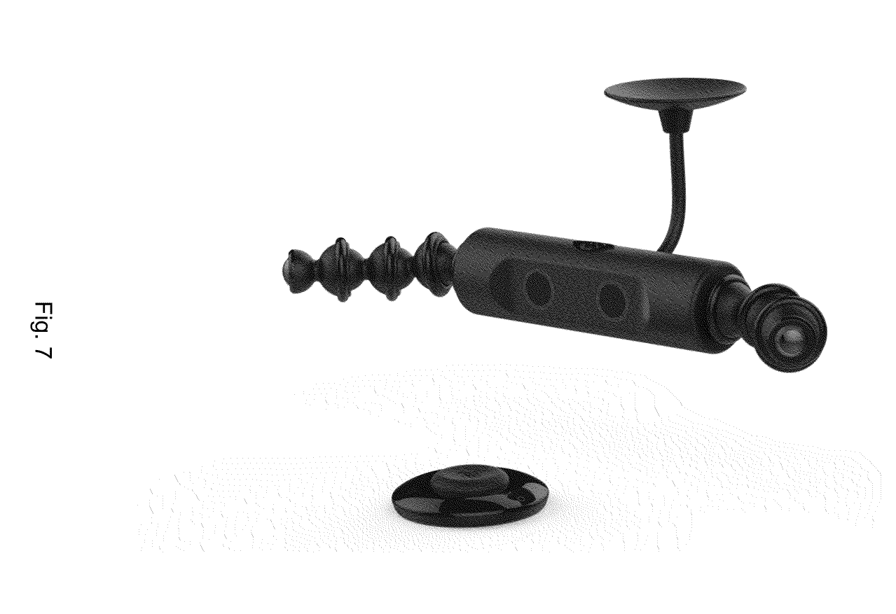

Referring now to FIG. 6, there is shown a view of the module system of one embodiment of the present disclosure. In one embodiment, a module is provided that can be adapted to be plugged into the automobile's on-board diagnostics port, via an OBD-II interface or other such interface. When plugged into the vehicle, the module may wirelessly connect to the camera system via a Bluetooth or other such wireless connection. The module system is then adapted to upload to the cloud-based computing server structure a variety of statistics which are tracked from the vehicle's on-board diagnostics electronic circuitry, including the vehicle's fuel efficiency, average speed, stopping characteristics, and the like. This data tracked by the module system is uploaded to the servers via a connection to a wireless communication network, such as LTE. Furthermore, in one embodiment of the present disclosure, the module system is further adapted to serve as a mobile data hotspot through which other mobile electronic devices are able to access the wireless communication network once connected to the module system. In an alternative embodiment of the present disclosure, the camera system comprises means to connect to a wireless communication network and is adapted to serve as a mobile data hotspot for mobile electronic devices. Conversely, signals received that are to be executed by the module system are received by the camera system and then transmitted to the module system via the wireless connection therewith.

The module system further comprises a means to initiate an emergency shutdown mode for the vehicle. Users are able to execute this action remotely via the web portal, software application, or other user interface in use. This provides users with a means to safely disable their vehicle if stolen or if accelerating out of control, protecting the vehicle from further harm.

The camera system and the module system of the present disclosure are both adapted to be installed semi-permanently to their respective locations as a safety measure. They are not permanently installed, however, removing these components requires a specialized tool, key, code, or other access means to remove the device, ensuring that the owner is able to remotely monitor the use of his or her vehicle at all times, without interference by thieves or other drivers who do not wish to be monitored.

Embodiments of this disclosure may allow parents, insurance companies, and other entities to improve the security and safe driving habits of drivers when behind the wheel of a vehicle. For example, the disclosed embodiments may provide a plurality of security and monitoring features, such as:
A minimally invasive device with a HD 175 degree angle camera on either end to give views of the interior and exterior of the vehicle. The device may be installed, for example on the dashboard, in the upper ceiling of the vehicle, or under the rearview mirror. One camera may be positioned for viewing of the road while driving, and the other may be positioned to view the driver and any other passengers in the vehicle.
When motion is detected the device may begin recording. As the device records footage to its internal storage, it may be uploaded periodically to a central server. The footage may be stored and accessible to associated users for a user-defined period of time.
In addition to the record, save, and upload logic of the device, users can also log into a web portal in communication with the server or device to view a live stream of both cameras at any time.
Footage may not be kept on internal device storage once it has been uploaded to the server, because users have the ability to view the video for a specific amount of time before it is saved or deleted. This minimizes the internal storage capacity required by the device itself.

Parents can effectively monitor their new drivers' behavior and correct unsafe habits, such as texting and driving, on demand, through the devices audio capabilities. After safe driving habits are displayed, new drivers can simply change the security login and continue to use the many other features of driver watchdog to keep themselves safe.

In case of emergency, the device may have a mobile remote panic button that can be placed either in the car or on the driver's key chain. Activating the panic button can trigger the recording of both cameras and send an emergency message to pre-determined contacts by email, text, or phone call. GPS information may be sent in the emergency message. Contacts are notified in the order you chose and will be sent a temporary 24-hour access code to be able to monitor the situation and contact the driver by enabling the audio capabilities.

Drivers in an accident are often in shock and may not be able to get to their phone. In the case of an accident, the device may detect a crash and automatically send emergency alerts based on accelerometer data, without user-input. The internally facing and externally facing cameras will record the accident and the data may be backed up for insurance purposes.

Some embodiments of the device may also include a fatigue sensor to help drivers stay alert. For example, software may detect head nodding and closed eyes and alert the driver.

Additionally, the device may have GPS capabilities to enable geofencing, i.e., allowing users to set boundaries of where their vehicle is permitted to travel as well as provides users with real time vehicle location. Fleet managers can manage their drivers more effectively and seniors or drivers with Dementia will now have virtual companion on their journey. If lost, a family member can see exactly where they are and guide them through the device's microphone in the right direction.

In one embodiment, all communication between the device and the central server may be secured by 512-bit TLS (transport layer security) end-to-end encryption. The device may also include a built-in SIM (Subscriber Identification Module) Card, which will be used to provide 4G mobile network connectivity. The device may authenticate itself to the central server using the SIM, which further hardens the infrastructure security. In one embodiment, the device may also act as a secure private WiFi hotspot for the vehicle.

In one embodiment, the device will need to be “activated” in order to begin using it. The user will visit a device-specific web portal and create an account using an e-mail address and the SIM ID from their device. This will provision the SIM Card with the Mobile Service Provider (such as AT&T or T-Mobile, Verizon, or Sprint) using a special plan. This plan may be paid for as a part of a monthly subscription fee the users will agree to pay.

Users may access the device's web portal over an SSL encrypted connection on port 443 (https://). In some embodiments, connections using port 80 or the plaintext HTTP protocol may be restricted. Communication between a device mobile app and the central server may be secured using the same or similar encryption.

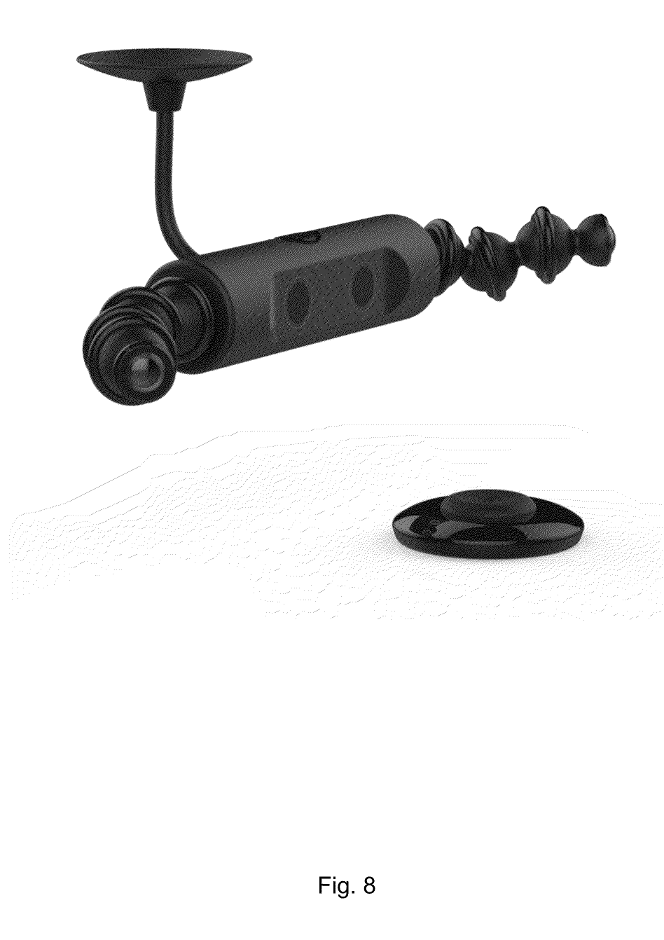

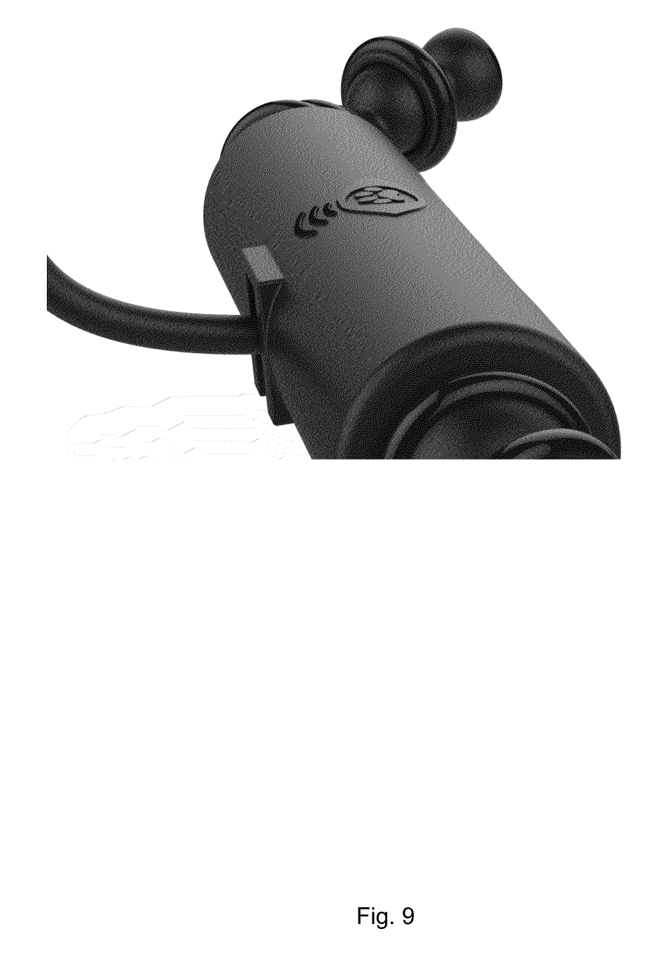

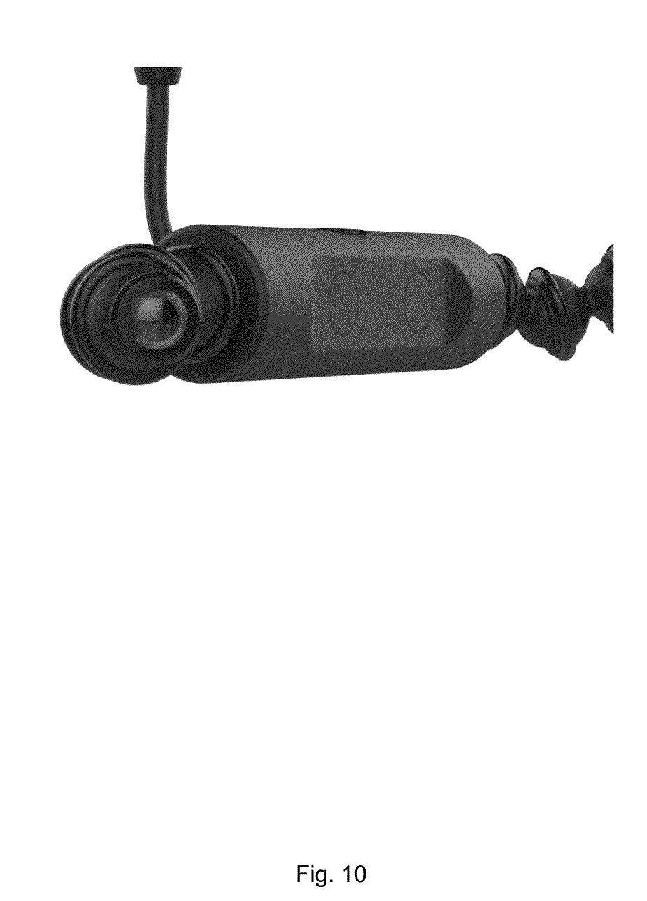

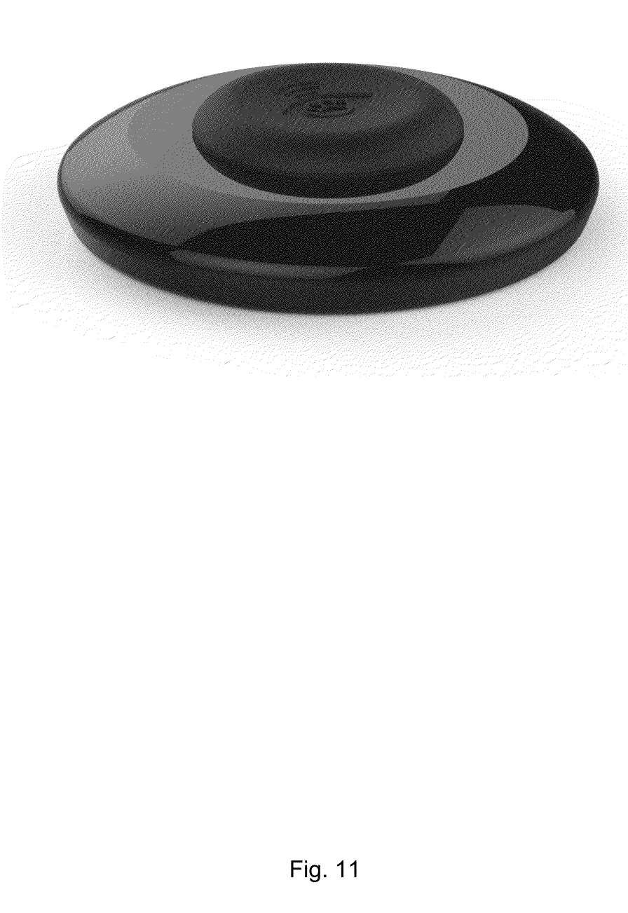

Referring now to FIGS. 7-11, there is shown an alternate version of the disclosed vehicle tracking device. In this alternate version of the vehicle tracking device, a plurality of actuators are shown on the front face. The flexible arms can be adjusted by the user.

The central server may perform a variety of functions, including:
Receiving vehicle diagnostic data from the optional OBD-II module and store it in an SQL database to be later accessed by other aspects of the system.
Receiving high-precision GPS “trip” data from the OBD-II module and storing it in such a way that it can be “replayed” next to video footage on a 2D or 3D map using a Google Maps engine via the front-end customer UI (browser or mobile device app).
Receiving video data from the in-car camera device and store it in a manner in which it can be later accessed by customers via the front-end UI or other aspects of the system. For example, the device may have limited onboard storage, but the central server may store all “trip” and “event” based footage.
In one embodiment, as video is recorded by the device, the video will be uploaded to the central server. The device itself will cache video footage locally until the server replies that the file was successfully uploaded, at which time the device may delete the locally stored video. If upload is interrupted or there is an error, video is maintained locally in the cache until there is a successful upload confirmed. The device will retry after a pre-defined period of time, for a pre-defined number of attempts. If video is unable to be uploaded to the server after the above thresholds are reached, a user alert will be sent via text or e-mail instructing user to plug device into their PC to manually upload trip data to server

The central server may also be configured to send e-mail and text alerts to users based on pre-defined events and thresholds, such as:
when a vehicle enters and leaves a “geo-fenced” area;
when the device needs to be recharged, loses connectivity, or has another error event;
when the vehicle exceeds certain speed thresholds;
when the vehicle is being used during a defined time period
when the vehicle security system enters an “alarm”, “theft-deterrent”, or other status which otherwise would require attention (applies to both active and passive alarm systems); and
when there are other events that are not yet defined here that users may or may not want notification of

The central server may also provide a user-facing front-end UI which will be accessible via a web browser or a mobile device app. This UI will allow users to review “trip” data that has been received from the device. Users will be allotted a default server storage capacity, and may be given the option to purchase additional storage, in tiers, on a subscription basis.

The UI may also allow the user to review an alerts dashboard which provides an overview of alerts received by the device, alerts that have recently been sent out by text or e-mail, and recent OBD-II events (if an OBD-II reader is included with the device. The UI may allow a user to define geo-fence areas, set time-based events, and configure other devices features. The UI may also allow a user to define user/administrator information and alert addresses (phone number and e-mail address verification). Provisioning and activating the device may be performed through the UI as well as managing other subscription and billing preferences and submitting electronic support tickets.

One embodiment of the present disclosure comprises a device with a durable plastic housing. The device may be battery operated and come equipped with a USB port for charging. Users may easily install the device by clip/suction cup attached to the housing.

Users will then create their profile and security credentials using an encrypted web portal accessed through any device with an internet connection. One version of the device has no screen as to not distract the driver.

The device may have a motion detection component that monitors the interior of the vehicle. The motion detection component can, for example, prevent theft and accidents involving children or pets left in hot cars.

Multiple configuration of the device are envisioned. For example one embodiment of the device may lack the OBD module component. Sensors, such as accelerometers and thermometers may be placed in the camera unit itself. The device may be a small unit with a HD wide angle camera on either end for the interior and exterior view of the vehicle.

Although the present disclosure has been described with respect to one or more particular embodiments, it will be understood that other embodiments of the present disclosure may be made without departing from the spirit and scope of the present disclosure. Hence, the present disclosure is deemed limited only by the appended claims and the reasonable interpretation thereof.

What is claimed is:

1. A vehicle monitoring and tracking device comprising:
a housing having at least one actuator;
two or more flexible arms having a first end and a second end, the first end of each arm attached to the housing, and the second end of each arm having a video camera;
a processor positioned within the housing, the processor in electronic communication with each of the video cameras;
a GPS receiver in electronic communication with the processor;
an accelerometer in electronic communication with the processor
a wireless data transceiver in electronic communication with the processor; and
an electronic data storage unit in electronic communication with the processor;
wherein the processor is configured to:
receive video from each video camera;
store the video from each video camera in the electronic data storage unit;
receive acceleration data and GPS data from the accelerometer and GPS receiver;
transmit, using the wireless data transceiver, at least a portion of the video, accelerometer data, and GPS data to a central server; and
receive input from the at least one actuator to control the operation of the device.

2. The device of claim 1, wherein the each camera is connected to the processor through a cavity in each flexible arm.

3. The device of claim 1, wherein at least one actuator is a button.

4. The device of claim 1, further comprising an OBD-II interface configured to pass vehicle information to the processor.

5. The device of claim 4, wherein the OBD-II interface is configured to pass vehicle information to the processor using RF communications.

6. The device of claim 4, wherein the OBD-II interface is configured to pass vehicle information to the processor using a wired connection.

7. The device of claim 1, wherein the processor is further configured to temporally associate the acceleration data and GPS data with the received video from each camera.

8. The device of claim 1, wherein video is only received and stored when the vehicle is in motion.

9. The device of claim 1, further comprising a mount configured to be removably attached to a surface in the vehicle.

10. A vehicle monitoring and tracking system comprising:
a plurality of vehicle tracking units, each unit comprising:
a housing having at least one actuator;
two or more flexible arms having a first end and a second end, the first end of each arm attached to the housing, and the second end of each arm having a video camera;
a processor positioned within the housing, the processor in electronic communication with each of the video cameras;
a GPS receiver in electronic communication with the processor;
an accelerometer in electronic communication with the processor
a wireless data transceiver in electronic communication with the processor; and
an electronic data storage unit in electronic communication with the processor;
wherein the processor is configured to:
receive video from each video camera;
store the video from each video camera in the electronic data storage unit;
receive acceleration data and GPS data from the accelerometer and GPS receiver;
transmit, using the wireless data transceiver, at least a portion of the video, accelerometer data, and GPS data to a central server; and
receive input from the at least one actuator to control the operation of the device;
a central server having a processor and electronic storage unit, the processor configured to:
receive video from each of the vehicle tracking units;
store at least a portion of the video from each of the vehicle tracking units in the electronic storage unit, such that the vehicle tracking unit is permanently associated with the stored video.

11. The system of claim 10, wherein the processor of the central server is further configured to store at least a portion of the GPS data and acceleration data from each of the vehicle tracking units, such that the vehicle tracking unit is permanently associated with the stored video.

12. The system of claim 10, wherein the processor of the central server is further configured to, upon a user's request, transmit data to one of the plurality of vehicle tracking units.

13. The system of claim 12, wherein the transmitted data to one of the plurality of vehicle tracking units is a shutdown command for the vehicle.

14. The system of claim 12, wherein the transmitted data to one of the plurality of vehicle tracking units is a command to move at least one of the cameras of the vehicle tracking unit.

15. The system of claim 10, wherein the electronic storage unit of the central server contains emergency contact information associated with each of the plurality of vehicle tracking units, and wherein the processor is configured to send a communication to the emergency contact information associated with the vehicle tracking unit upon one or more pre-determined parameters.

16. The system of claim 12, wherein the transmitted data to one of the plurality of vehicle tracking units is voice data.

17. The system of claim 10, wherein the central server processor is further configured to receive geofencing data associated with one of the plurality of vehicle tracking units.
